(19) United States
(12) Patent Application Publication
(10) Pub. No.: US 2023/0291941 A1
(43) Pub. Date: Sep. 14, 2023

(54) TERMINAL DEVICE CONTROL METHOD, CONTENT PROVISION DEVICE, AND CONTENT PROVISION METHOD

(71) Applicant: HONDA MOTOR CO., LTD., Tokyo (JP)

(72) Inventors: Tomoaki Hagihara, Tokyo (JP); Takashi Miyata, Tokyo (JP); Taiki Yamada, Tokyo (JP)

(21) Appl. No.: 18/117,500

(22) Filed: Mar. 6, 2023

(30) Foreign Application Priority Data
Mar. 8, 2022 (JP) 2022-035664

(51) Int. Cl. H04N 21/2387; H04N 21/414

(52) U.S. Cl. CPC H04N 21/2387; H04N 21/41422

(57) ABSTRACT

A terminal device control method to be executed using a terminal device includes acquiring a playlist of one or more pieces of content to which one or more pieces of tag information are assigned, displaying playing content and scheduled playback content to be played after the playing content on the basis of the playlist, displaying one or more tags assigned to the playing content in a state in which the one or more tags are classified into a top tag and a non-top tag, moving the non-top tag that has been manipulated to a position of the top tag when the non-top tag has been manipulated to set the moved non-top tag as a new top tag, and acquiring a playlist of content related to the new top tag to replace the scheduled playback content with content related to the new top tag.

### CROSS-REFERENCE TO RELATED APPLICATION

Priority is claimed on Japanese Patent Application No. 2022-035664, filed Mar. 8, 2022, the content of which is incorporated herein by reference.

### BACKGROUND

### Field of the Inventions

The present invention relates to a terminal device control method, a content provision device, and a content provision method.

### Description of Related Art

In the related art, an invention of a device for automatically recommending a sound for a user is disclosed (Japanese Unexamined Patent Application, First Publication No. 2021-149568).

### SUMMARY

A tag indicating an attribute or the like may be given to content such as a sound and the tag may be displayed as the content is played. In the related art, a method of performing content control in accordance with a tag manipulation is not taken into account.

The present invention has been made in consideration of such circumstances and an objective thereof is to provide a terminal device control method, a content provision device, and a content provision method capable of performing preferred display control in accordance with a tag manipulation.

A terminal device control method, a content provision device, and a content provision method according to the present invention adopt the following configurations.

(1): According to an aspect of the present invention, there is provided a terminal device control method to be executed using a terminal device having at least a display unit and a processor, the terminal device control method including: acquiring a playlist of one or more pieces of content to which one or more pieces of tag information are assigned; displaying playing content and scheduled playback content to be played after the playing content on the basis of the playlist; displaying one or more tags assigned to the playing content in a state in which the one or more tags are classified into a top tag and a non-top tag; and moving the non-top tag that has been manipulated to a position of the top tag when the non-top tag has been manipulated to set the moved non-top tag as a new top tag and acquiring a playlist of content related to the new top tag to replace the scheduled playback content with content related to the new top tag.

(2): In the above-described aspect (1), the terminal device control method further includes playing one piece of content within the scheduled playback content when playback of the playing content ends after the scheduled playback content is replaced with the content related to the new top tag.

(3): In the above-described aspect (1), the terminal device control method further includes displaying one or more pieces of previously played content together with the playing content and the scheduled playback content, wherein the terminal device does not switch the one or more pieces of previously played content when the scheduled playback content is replaced with the content related to the new top tag by manipulating the non-top tag.

(4): In the above-described aspect (1), the terminal device control method further includes displaying a tag different from a tag displayed in association with previous playing content among tags displayed in association with new playing content separately from a tag identical to a tag displayed in association with the previous playing content among the tags displayed in association with the new playing content when playback of the playing content ends and playback of the new playing content is started.

(5): In the above-described aspect (1), the terminal device control method further includes displaying a different part between the scheduled playback content before the replacement and the scheduled playback content after the replacement separately from a common part between the scheduled playback content before the replacement and the scheduled playback content after the replacement as a result of replacing the scheduled playback content with the content related to the new top tag when the non-top tag has been manipulated.

(6): According to another aspect of the present invention, there is provided a content provision device including: a communication unit configured to communicate with a terminal device having at least a display unit and a processor; and an automated playback control unit configured to cause a sequential playback process to be performed by transmitting a playlist of one or more pieces of content to which one or more pieces of tag information are assigned to the terminal device via the communication unit, wherein, when playing content and scheduled playback content to be played after the playing content are displayed on the basis of the playlist and a non-top tag is manipulated in a display screen of the terminal device that displays one or more tags assigned to the playing content in a state in which the one or more tags are classified into a top tag and the non-top tag, the automated playback control unit transmits a playlist of content related to the non-top tag to the terminal device via the communication unit, moves the non-top tag that has been manipulated to a position of the top tag to set the moved non-top tag as a new top tag, and replaces the scheduled playback content with content related to the new top tag.

(7): In the above-described aspect (6), the automated playback control unit sets a tag specific to the user on the basis of a playback history of each user.

(8): According to still another aspect of the present invention, there is provided a content provision method including: communicating, by a content provision device, with a terminal device having at least a display unit and a processor; and causing, by the content provision device, a sequential playback process to be performed by transmitting a playlist of one or more pieces of content to which one or more pieces of tag information are assigned to the terminal device via a communication unit, wherein causing the sequential playback process to be performed includes, when playing content and scheduled playback content to be played after the playing content are displayed on the basis of the playlist and a non-top tag is manipulated in a display screen of the terminal device that displays one or more tags assigned to the playing content in a state in which the one or more tags are classified into a top tag and the non-top tag, transmitting a playlist of content related to the non-top tag to the terminal device via the communication unit, moving the non-top tag that has been manipulated to a position of the top tag to set the moved non-top tag as a new top tag, and replacing the scheduled playback content with content related to the new top tag.

According to the aspects (1) to (8), it is possible to perform preferred display control in accordance with a tag manipulation.

### BRIEF DESCRIPTION OF THE DRAWINGS

FIG. 1 is a configuration diagram of a content provision system using an application program and a content provision device according to an embodiment.

FIG. 2 is a diagram showing an example of content of user information.

FIG. 3 is a diagram showing an example of content of sound data.

FIG. 4 is a diagram showing an example of content of a reverse tag index.

FIG. 5 is a diagram showing an example of a basic display screen in an automated playback mode.

FIG. 6 is a diagram showing an example of a new basic display screen displayed when the playback of a playing sound ends on the basic display screen.

FIG. 7 is a diagram showing an example of the screen transition from the basic display screen to a tag manipulation screen when a non-top tag is manipulated.

### DESCRIPTION OF EMBODIMENTS

Hereinafter, embodiments of a terminal device control method, a content provision device, and a content provision method of the present invention will be described with reference to the drawings.

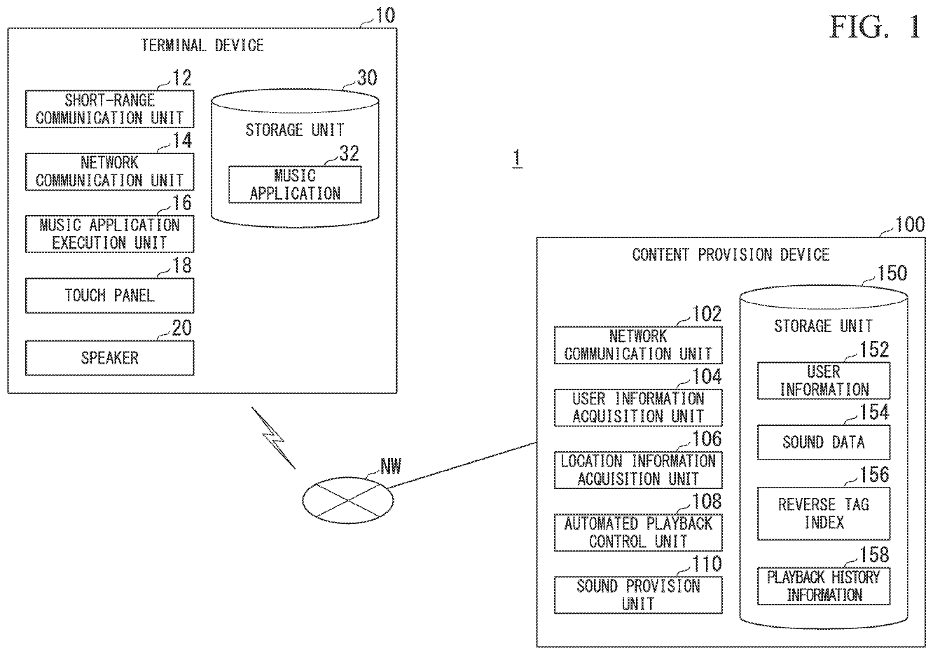

FIG. 1 is a configuration diagram of a content provision system 1 using an application program and a content provision device according to an embodiment. The content provision system 1 is a system that provides content to a user's terminal device. The content is, for example, sounds. The sounds are music and may include environmental sounds and the like as well as an artist's song, musical performance, or program-played music. Although it is assumed that the content is a sound in the following description, the content may be video content with an image or the like. The terminal device is, for example, a smartphone or a tablet terminal. Also, the terminal device may be an in-vehicle device mounted in a moving object such as a vehicle. Also, the terminal device may be a smartphone or a tablet terminal and may be one that plays a sound on an in-vehicle device or a wireless earphone in a short-range wireless mode. The moving object includes, for example, a vehicle with a space for an occupant to stay (a vehicle with four or three wheels, micromobility, or the like), a watercraft, an aircraft, or a two-wheeled vehicle. In the case of the two-wheeled vehicle, an audio device provided in a helmet may function as the terminal device.

### [Portable Terminal Device]

The terminal device 10 is, for example, a portable computer device having a communication function, an input/output function (a display function) and an application execution function of a processor such as a smartphone or a tablet terminal. The terminal device 10 includes, for example, a short-range communication unit 12, a network communication unit 14, a music application execution unit 16, a touch panel 18, and a speaker 20.

The short-range communication unit 12 performs wireless or wired communication with an in-vehicle device or a wireless earphone on the basis of a communication standard such as Bluetooth (registered trademark), Wi-Fi, or Universal Serial Bus (USB).

The network communication unit 14 communicates with a content provision device 100 via a network NW. The network NW includes a radio base station, an access point, the Internet, a provider terminal, a wide area network (WAN), and the like.

The music application execution unit 16 functions when a processor such as a central processing unit (CPU) executes a music application 32 stored in a storage unit 30. The music application execution unit 16 controls each part of the terminal device 10 in accordance with an input manipulation of a user performed on the touch panel 18. For example, the music application 32 is installed on the terminal device 10 in advance from a server device of the application provider.

The music application execution unit 16 performs a process of acquiring a sound from the content provision device 100 in, for example, a streaming format, and causing the speaker 20 or the like (the speaker 20, an in-vehicle device that is a short-distance communication partner, a wireless earphone, or the like) to play the sound. The music application execution unit 16 operates in various types of modes such as a single mode in which the user is allowed to designate sounds one by one, and an automated playback mode in which sounds are played sequentially in the order recommended by the content provision device 100 after the designation of one sound is received.

### [Content Provision Device]

The content provision device 100 includes, for example, a network communication unit 102, a user information acquisition unit 104, a location information acquisition unit 106, an automated playback control unit 108, a sound provision unit 110, and a storage unit 150. Components other than the network communication unit 102 and the storage unit 150 are implemented, for example, by a hardware processor such as a CPU executing a program (software). Some or all of these components may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be prestored in a storage device (a storage device including a non-transitory storage medium) such as a hard disk drive (HDD) or a flash memory or may be stored in a removable storage medium (a non-transitory storage medium) such as a digital video disc (DVD) or a compact disc-read-only memory (CD-ROM) and installed when the storage medium is mounted in a drive device. The storage unit 150 stores information such as user information 152, sound data 154, a reverse tag index 156, and playback history information 158.

The network communication unit 102 communicates with the terminal device 10 via the network NW.

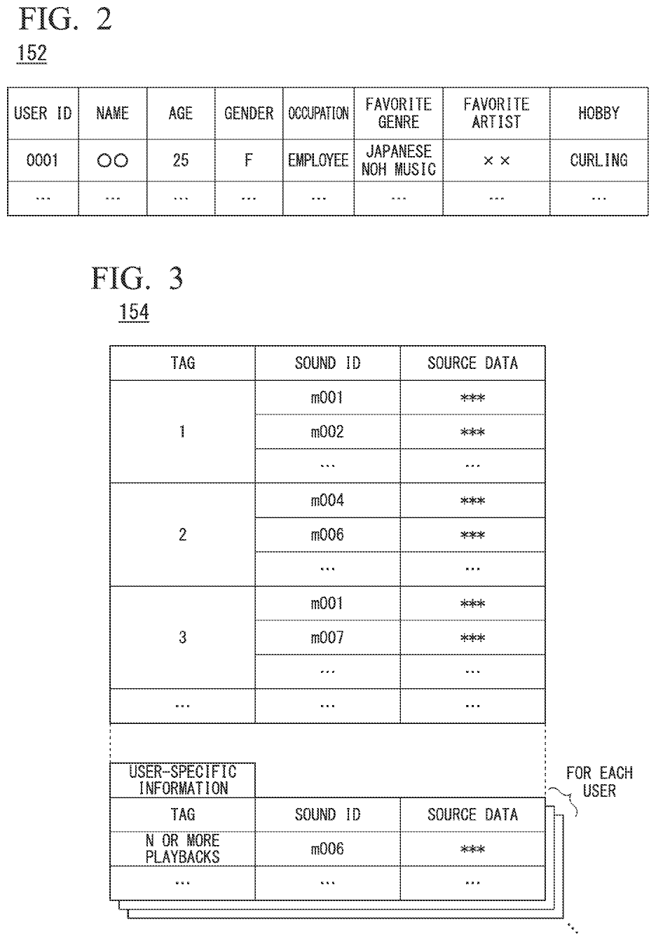

The user information acquisition unit 104 acquires information of a user (user information) of the terminal device 10 and registers the acquired user information in the user information 152. FIG. 2 is a diagram showing an example of content of the user information 152. The user information 152 includes, for example, a name, age, gender, occupation, favorite music genre, preferred artist, hobby, and the like, and user feature information derived therefrom. The user information acquisition unit 104 appropriately updates the user information 152 in accordance with an input manipulation of the user or on the basis of a sound playback history.

The location information acquisition unit 106 acquires the user's location information. The user's location information is measured, for example, by a location measurement device (a Global Positioning System (GPS) receiver or the like (not shown)) provided in the terminal device 10 and transmitted to the content provision device 100. Also, the user's location information may be acquired from the in-vehicle device that is the terminal device 10 using short-distance communication.

The automated playback control unit 108 functions when the music application execution unit 16 operates in the automated playback mode. The automated playback control unit 108 refers to the reverse tag index 156 generated on the basis of the sound data 154 and selects a sound to be subsequently played (hereinafter, a scheduled playback sound that is an example of scheduled playback content) in relation to a playing sound (hereinafter, the playing sound that is an example of playing content).

FIG. 3 is a diagram showing an example of content of the sound data 154. In the sound data 154, for example, sound IDs of one or more sounds belonging (applicable, corresponding, or related) to a tag indicating a genre or theme and sound source data are associated with the tag. One sound may belong to a plurality of tags. The tags may include thematic items such as a sound suitable for summer and a sound related to a particular region as well as genres such as classical, jazz, hard rock, and hip-hop. The number of playbacks, sound feature information for determining a degree of compatibility with a user, and the like are associated with the sound. The tag may be acquired as metadata associated with the sound at the point in time when the data is registered in the sound data 154 or may be automatically assigned a sound belonging to a tag indicating “the sound suitable for the summer” by the automated playback control unit 108 on the assumption that “the number of playbacks is larger in the summer” on the basis of the playback history information 158. Also, the automated playback control unit 108 may further automatically assign a tag indicating the sound related to the specific region to a sound whose number of playbacks is large in the specific region with reference to location information of the user.

The sound data 154 may include user-specific information. In the user-specific information is, for example, a sound ID is associated with a tag indicating a sound played n or more times, a sound registered as a favorite, or a sound played one year ago. The automated playback control unit 108 generates the user-specific information on the basis of the playback history information 158 and the like in advance and adds the user-specific information to the sound data 154. The playback history information 158 includes a playback history (a sound ID, a playback date and time, and the like) for each user, a playback history for each sound, or statistical information thereof.

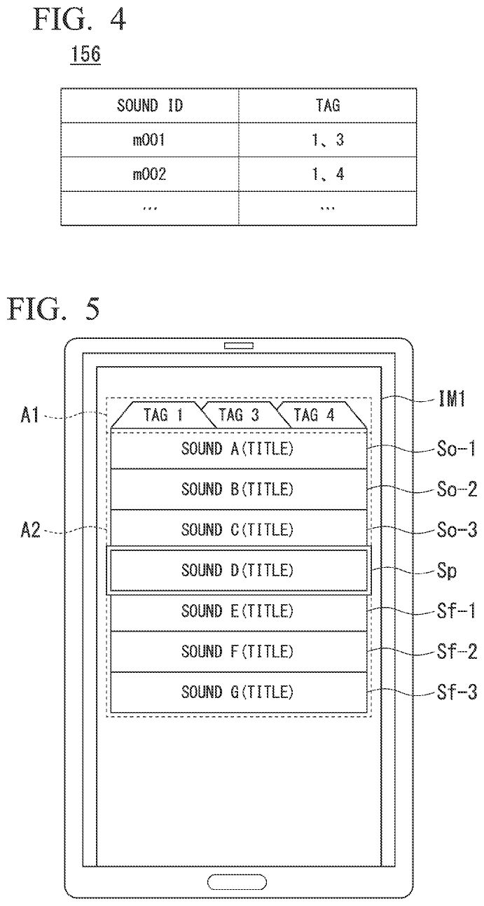

FIG. 4 is a diagram showing an example of content of the reverse tag index 156. The reverse tag index 156 makes it possible to search for one or more tags to which a sound indicated by the sound ID belongs using the sound ID as a search query. Tags corresponding to sound IDs are ranked.

The automated playback control unit 108 refers to, for example, the user information 152, the sound data 154, and the playback history information 158, performs a ranking process on the basis of the assumption that the number of playbacks is large, a degree of compatibility between user feature information and sound feature information is high, and an excessive playback has not been performed recently with respect to other sounds to which a tag identical to that of a playing sound is assigned, and selects a scheduled playback sound on the basis of ranking results. The automated playback control unit 108 transmits a playlist in which scheduled playback sounds are listed to the terminal device 10 and transfers the playlist to the sound provision unit 110. The playlist is information in which a tag to which the scheduled playback sound belongs is associated with each of the scheduled playback sounds. When a playlist is generated, the automated playback control unit 108 acquires information of the tag to which the selected sound belongs using the reverse tag index 156. Also, the automated playback control unit 108 or the sound provision unit 110 acquires information of the tag to which the designated sound belongs using the reverse tag index 156 even for the sound designated by the user and provides the information to the terminal device 10.

The sound provision unit 110 sequentially transmits sounds designated by the user or transferred as a playlist to the terminal device 10 in a streaming format.

### [Screen Control]

Hereinafter, screen control of the terminal device 10 in the automated playback mode will be described.

A display screen to be described below is rendered by the music application execution unit 16 on the basis of a playlist or the like received from the content provision device 100 and displayed on the touch panel 18.

FIG. 5 is a diagram showing an example of a basic display screen IM1 in the automated playback mode. The basic display screen IM1 includes, for example, a tag display area A1 and a sound display area A2. In the tag display area A1 in the basic display screen IM1, tags to which a playing sound belongs are displayed in order of rankings. For example, a tag having a first ranking is displayed on a leftmost and frontmost side. This tag is referred to as a top tag. Tags having a second ranking, a third ranking, and the like are displayed at a second position, a third position, and the like from the left in FIG. 5. Each of these tags is referred to as a non-top tag. In the sound display area A2, for example, one or more previously played sounds (hereinafter referred to as played sounds) So-1, So-2, and the like, a playing sound Sp, one or more scheduled playback sounds Sf-1, Sf-2, and the like are displayed.

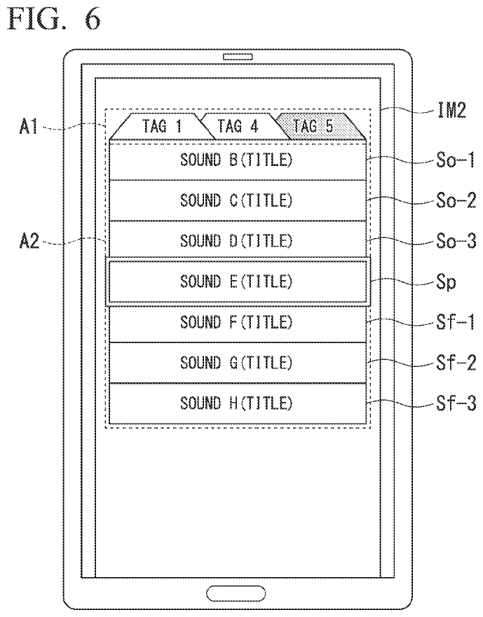

If the playback of the playing sound ends, when the scheduled playing sound Sf-1 is displayed as a new playing sound, a configuration of a tag to which the new playing sound belongs may be different from a configuration of a tag to which the previous playing sound belongs. FIG. 6 is a diagram showing an example of a new basic display screen IM2 displayed when playback of the playing sound ends in the basic display screen IM1. Tags to which a previous playing sound D belongs are Tag 1, Tag 3, and Tag 4, while tags to which a new playing sound E belongs are Tag 1, Tag 4, and Tag 5. In this case, the music application execution unit 16 causes the touch panel 18 to display (for example, conspicuously highlight) Tag 5, which is a tag difference between the sound D and the sound E, separately from Tag 1 and Tag 4, which are common tags between the sound D and the sound E. Thereby, it is possible to allow the user to easily select a new tag as the sound changes.

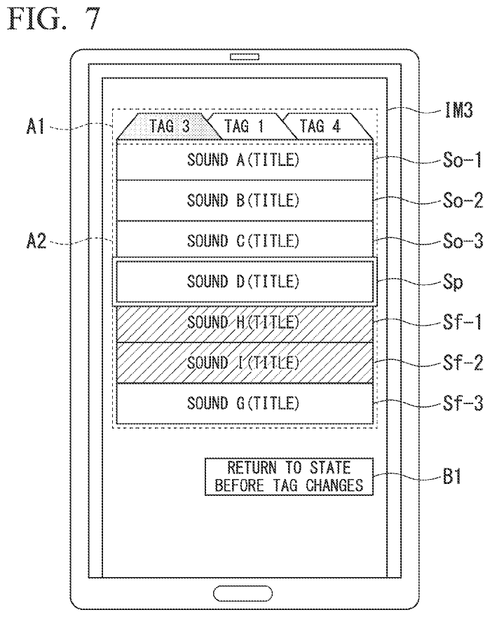

Returning to the basic display screen IM1, when a non-top tag is manipulated while the playing sound is being played, the music application execution unit 16 performs the following process. FIG. 7 is a diagram showing an example of the screen transition from the basic display screen IM1 to a tag manipulation screen IM3 when the non-top tag is manipulated. The music application execution unit 16 moves the manipulated non-top tag to a position of the top tag to set the manipulated non-top tag as a new top tag, acquires a playlist associated with the new top tag from the content provision device 100, and replaces the scheduled playback sound with content related to the new top tag. In FIG. 7, it is assumed that Tag 3 has been selected. By switching the top tag, the automated playback control unit 108 preferentially selects a sound belonging to the new top tag. As a result, there is a high possibility that the scheduled playback sound will be changed. Therefore, the music application execution unit 16 causes the content provision device 100 to select the scheduled playback sound again and replaces the display as described above. The music application execution unit 16 may cause the touch panel 18 to display (for example, conspicuously highlight) the new top tag separately from the non-top tags and/or may cause the touch panel 18 to display (for example, conspicuously highlight) different sounds between before and after the replacement of the scheduled playback sound separately from the common sounds. Thereby, the user can first check sounds to be subsequently played and the convenience can be improved.

Also, a button B1 for accepting an “undo” manipulation may be set on a tag manipulation screen IM3. When this button is manipulated, the music application execution unit 16 returns the display screen to the basic display screen IM1 and notifies the content provision device 100 of the screen return. The music application execution unit 16 does not change the played sound from the basic display screen IM1 on the tag manipulation screen IM3 and leaves it as it is.

Even after the tag manipulation screen IM3 is displayed, the playback of the playing sound (a sound D in FIG. 7) continues. When the playback of the playing sound ends, the playback of a highest-ranking scheduled playback sound selected in association with the new top tag (a sound H in FIG. 7) starts.

Although the selection of the tag is mainly left to the manipulation of the user in the above-described embodiment, a tag indicating a sound suitable for a region where the user is located may be recommended on the basis of the user's location information.

According to the above-described embodiment, it is possible to perform preferred display control in accordance with a tag manipulation by acquiring a playlist of one or more pieces of content (sounds) to which one or more pieces of tag information are assigned; displaying playing content and scheduled playback content to be played after the playing content on the basis of the playlist; displaying one or more tags assigned to the playing content in a state in which the one or more tags are classified into a top tag and a non-top tag; and moving the non-top tag that has been manipulated to a position of the top tag when the non-top tag has been manipulated to set the moved non-top tag as a new top tag and acquiring a playlist of content related to the new top tag to replace the scheduled playback content with content related to the new top tag.

In the above-described embodiment, the content provision device 100 may render a display screen of the terminal device 10. In this case, the display control described above is executed by the content provision device 100. For example, the automated playback control unit 108 may perform display control equivalent to that of the music application execution unit 16 described above, and transmit an image to the terminal device 10 in a format of a webpage or the like.

Although modes for carrying out the present invention have been described using embodiments, the present invention is not limited to the embodiments and various modifications and substitutions can also be made without departing from the scope and spirit of the present invention.

What is claimed is:

1. A terminal device control method to be executed using a terminal device having at least a display unit and a processor, the terminal device control method comprising:
acquiring a playlist of one or more pieces of content to which one or more pieces of tag information are assigned;
displaying playing content and scheduled playback content to be played after the playing content on the basis of the playlist;
displaying one or more tags assigned to the playing content in a state in which the one or more tags are classified into a top tag and a non-top tag; and
moving the non-top tag that has been manipulated to a position of the top tag when the non-top tag has been manipulated to set the moved non-top tag as a new top tag and acquiring a playlist of content related to the new top tag to replace the scheduled playback content with content related to the new top tag.

2. The terminal device control method according to claim 1,
further comprising playing one piece of content within the scheduled playback content when playback of the playing content ends after the scheduled playback content is replaced with the content related to the new top tag.

3. The terminal device control method according to claim 1,
further comprising displaying one or more pieces of previously played content together with the playing content and the scheduled playback content,
wherein the terminal device does not switch the one or more pieces of previously played content when the scheduled playback content is replaced with the content related to the new top tag by manipulating the non-top tag.

4. The terminal device control method according to claim 1,
further comprising displaying a tag different from a tag displayed in association with previous playing content among tags displayed in association with new playing content separately from a tag identical to a tag displayed in association with the previous playing content among the tags displayed in association with the new playing content when playback of the playing content ends and playback of the new playing content is started.

5. The terminal device control method according to claim 1,
further comprising displaying a different part between the scheduled playback content before the replacement and the scheduled playback content after the replacement separately from a common part between the scheduled playback content before the replacement and the scheduled playback content after the replacement as a result of replacing the scheduled playback content with the content related to the new top tag when the non-top tag has been manipulated.

6. A content provision device comprising:
a communication unit configured to communicate with a terminal device having at least a display unit and a processor; and
an automated playback control unit configured to cause a sequential playback process to be performed by transmitting a playlist of one or more pieces of content to which one or more pieces of tag information are assigned to the terminal device via the communication unit,
wherein, when playing content and scheduled playback content to be played after the playing content are displayed on the basis of the playlist and a non-top tag is manipulated in a display screen of the terminal device that displays one or more tags assigned to the playing content in a state in which the one or more tags are classified into a top tag and the non-top tag, the automated playback control unit transmits a playlist of content related to the non-top tag to the terminal device via the communication unit, moves the non-top tag that has been manipulated to a position of the top tag to set the moved non-top tag as a new top tag, and replaces the scheduled playback content with content related to the new top tag.

7. The content provision device according to claim 6, wherein the automated playback control unit sets a tag specific to the user on the basis of a playback history of each user.

8. A content provision method comprising:
communicating, by a content provision device, with a terminal device having at least a display unit and a processor; and
causing, by the content provision device, a sequential playback process to be performed by transmitting a playlist of one or more pieces of content to which one or more pieces of tag information are assigned to the terminal device via a communication unit,
wherein causing the sequential playback process to be performed includes, when playing content and scheduled playback content to be played after the playing content are displayed on the basis of the playlist and a non-top tag is manipulated in a display screen of the terminal device that displays one or more tags assigned to the playing content in a state in which the one or more tags are classified into a top tag and the non-top tag, transmitting a playlist of content related to the non-top tag to the terminal device via the communication unit, moving the non-top tag that has been manipulated to a position of the top tag to set the moved non-top tag as a new top tag, and replacing the scheduled playback content with content related to the new top tag.
